(19) United States
(12) Patent Application Publication
(10) Pub. No.: US 2026/0168615 A1
(43) Pub. Date: Jun. 18, 2026

(54) MOUNT FOR SINGLE-HANDED CONTROL OF ROTATABLE JOINTS

(71) Applicant: SHENZHEN MOSENMO INDUSTRIAL CO., LTD, SHENZHEN (CN)

(72) Inventor: SHENGHU AN, SHENZHEN (CN)

(21) Appl. No.: 19/532,147

(22) Filed: Feb. 6, 2026

(30) Foreign Application Priority Data
Dec. 5, 2025 (CN) 202511828023.6

(51) Int. Cl. F16M 11/20

(52) U.S. Cl. CPC F16M 11/2021; F16M 2200/024; F16M 2200/065; F16M 2200/068

(57) ABSTRACT

A mount for single-handed control of rotatable joints includes a first support rod. A rear end of the first support rod is rotatably connected to a second support rod and a third support rod. When a button is pressed, a main slider slides forward to deform a first elastic device, so that a first tooth disengages from a first gear and a second tooth disengages from a second gear, and the first support rod and the second support rod are rotatable. When the button resets, the first elastic device resets to slide the main slider backward, so that the first tooth is engaged with the first gear to limit a rotation of the first support rod relative to the second support rod, and the second tooth is engaged with the second gear to limit a rotation of the second support rod relative to the third support rod.

### TECHNICAL FIELD

The present disclosure relates to a field of mounts, and in particular to a mount for single-handed control of rotatable joints.

### BACKGROUND

Besides handheld use, electronic or photographic devices (such as desk lamps, cameras, camcorders, mobile phones, tablets, etc.) are typically used by adjusting their spatial position through electronic device mounts. Furthermore, when using the electronic devices, it is commonly necessary to adjust an position of the electronic device mounts vertically and/or horizontally. Joints of conventional electronic device mounts are only allowed to be adjusted by loosening joint screws during adjustment, and an adjustment operation thereof is cumbersome and requires both hands. These electronic device mounts are ineffective when a quick, one-handed adjustment of the position of the electronic devices is needed.

### SUMMARY

To solve problems in the prior art, the present disclosure provides a mount for single-handed control of rotatable joints.

The mount comprises a first support rod. A rear end of the first support rod is at least rotatably connected to a second support rod and a third support rod. The second support rod and the third support rod are connected in sequence.

A button is disposed on the first support rod, a main slider is disposed in the first support rod. A first tooth is disposed at a rear end of the main slider. A first gear is fixed at a rotatable joint of the first support rod and the second support rod. The first tooth is configured to limit a rotation of the first support rod relative to the second support rod when the first tooth is engaged with the first gear.

The main slider is connected with a first end of at least one connecting line. A second tooth is disposed on a second end of the at least one connecting line. A second gear is fixed at a rotatable joint of the second support rod and the third support rod. The second tooth is configured to limit a rotation of the second support rod relative to the third support rod when the second tooth is engaged with the second gear.

A first elastic device is disposed on the second tooth. When the button is pressed, the main slider slides forward to deform the first elastic device, so that the first tooth disengages from the first gear and the second tooth disengages from the second gear, and the first support rod and the second support rod are rotatable relative to each other. When the button resets, the first elastic device resets to slide the main slider backward, so that the first tooth is engaged with the first gear to limit the rotation of the first support rod relative to the second support rod, and the second tooth is engaged with the second gear to limit the rotation of the second support rod relative to the third support rod.

In one optional embodiment, the first tooth and the second tooth are pawls, and the first gear and the second gear are ratchets.

In one optional embodiment, the at least one connecting line comprises a steel cable disposed therein and a protective sleeve sleeved on the steel cable.

In one optional embodiment, the main slider comprises a button slider and a first limiting slider. The button slider and the first limiting slider are slidably disposed in the first support rod. The button slider and the first limiting slider are connected and linked by a joint rod. The first tooth is disposed on a front end of the first limiting slider.

In one optional embodiment, a second elastic device is disposed between the first limiting slider and the first support rod.

In one optional embodiment, the first end of the at least one connecting line is fixed on the first limiting slider. The second end of the at least one connecting line is fixed to a second limiting slider. The second tooth is disposed on a front end of the second limiting slider. The first elastic device is disposed between the second limiting slider and the second support rod.

In one optional embodiment, the button comprises a button shell. A pressing block is fixed on the button shell. A first end of a connecting rod is rotatably connected to the pressing block. A second end of the connecting rod is rotatably connected to the main slider. When the button shell is pressed, the pressing block moves inward along a radial direction of the first support rod, so that the connecting rod swings and drives the main slider to slide forward.

In one optional embodiment, a front end of the first support rod is connected to a ball head assembly.

In one optional embodiment, the first limiting slider is slidably disposed on the rear end of the first support rod, and the first gear is fixed to an end of the second support rod close to the first support rod.

In one optional embodiment, the second limiting slider is slidably disposed on a rear end of the second support rod, and the second gear is fixed to one end of the third support rod close to the second support rod.

In the present disclosure, the button drives the main slider to slide, causing the main slider to engage with a first rotatable joint of the mount. The least one connecting line is connected to the main slider. The least one connecting line disengages rotatable joints at a rear portion of the mount, allowing the rotatable joints of the mount to separate and rotate freely when the button is pressed. Thus, when rotating the mount with the rotatable joints, a user may only use one hand to press the button to separate the rotatable joints, then the user is allowed to adjust a position of the mount, so that a front end of the mount is rotated to a desired location. After adjustment, the user may release the button to engage protruding teeth (i.e., the first tooth and the second tooth) respectively with gears (i.e., the first gear and the second gear), thereby fixing the mount in the desired location. Therefore, this mount offers a technical effect of allowing single-handed control of the rotatable joints to rotate to the desired location.

### BRIEF DESCRIPTION OF DRAWINGS

FIG. 1 is an exploded schematic diagram of a mount for single-handed control of rotatable joints according to one embodiment of the present disclosure.

FIG. 2 is a cross-sectional schematic diagram of the mount according to one embodiment of the present disclosure, where a first support rod is connected to a second support rod.

FIG. 3 is another cross-sectional schematic diagram of the mount according to one embodiment of the present disclosure, where a third support rod is connected to the second support rod.

FIG. 4 is a schematic diagram of a first limiting slider according to one embodiment of the present disclosure.

FIG. 5 is a schematic diagram of a second limiting slider according to one embodiment of the present disclosure.

### DETAILED DESCRIPTION

With reference to the embodiments and accompanying drawings, the present disclosure is further described in detail below.

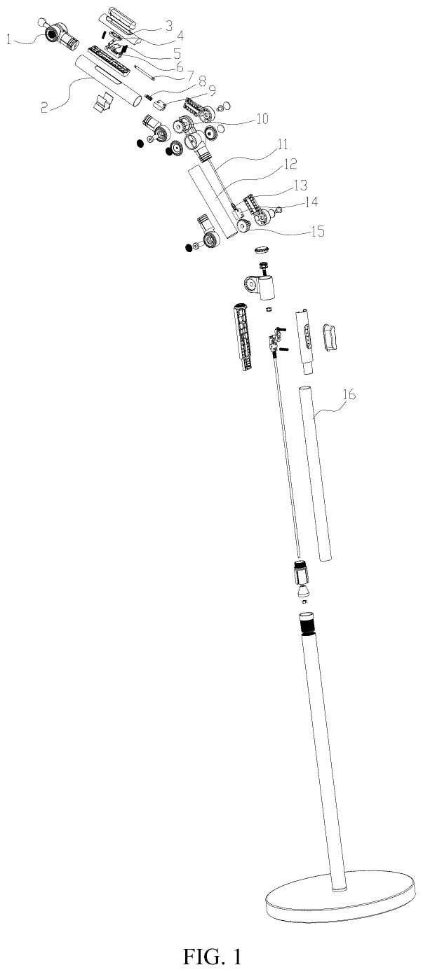

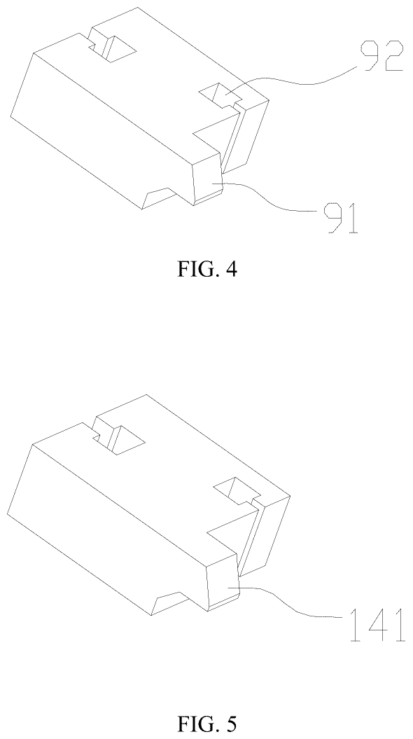

As shown in FIGS. 1-5, the present disclosure provides a mount for single-handed control of rotatable joints.

The mount comprises a first support rod 2. A rear end of the first support rod 2 is at least rotatably connected to a second support rod 12 and a third support rod 16. The second support rod 12 and the third support rod 16 are connected in sequence.

A button is disposed on the first support rod 2, a main slider is disposed in the first support rod 2. A first tooth 91 is disposed at a rear end of the main slider. A first gear 10 is fixed at a rotatable joint of the first support rod 2 and the second support rod 12. The first tooth 91 is configured to limit a rotation of the first support rod 2 relative to the second support rod 12 when the first tooth 91 is engaged with the first gear 10.

The main slider is connected with a first end of at least one connecting line 11. A second tooth 141 is disposed on a second end of the at least one connecting line 11. A second gear 15 is fixed at a rotatable joint between the second support rod 12 and the third support rod 16. The second tooth 141 is configured to limit a rotation of the second support rod 12 relative to the third support rod 16 when the second tooth 141 is engaged with the second gear 15.

A first elastic device 13 is disposed on the second tooth 141. When the button is pressed, the main slider slides forward to deform the first elastic device 13, so that the first tooth 91 disengages from the first gear 10 and the second tooth 141 disengages from the second gear 15, and the first support rod 2 and the second support rod 12 are rotatable relative to each other. When the button resets, the first elastic device 13 resets to slide the main slider backward, so that the first tooth 91 is engaged with the first gear 10 to limit the rotation of the first support rod 2 relative to the second support rod 12, and the second tooth 141 is engaged with the second gear 15 to limit the rotation of the second support rod 12 relative to the third support rod 16.

In the present disclosure, the button drives the main slider to slide, causing the main slider to engage with a first rotatable joint of the mount. The least one connecting line 11 is connected to the main slider. The least one connecting line 11 disengages rotatable joints at a rear portion of the mount, allowing the rotatable joints of the mount to separate and rotate freely when the button is pressed. Thus, when rotating the mount with the rotatable joints, a user may only use one hand to press the button to separate the rotatable joints, then the user is allowed to adjust a position of the mount, so that a front end of the mount is rotated to a desired location. After adjustment, the user may release the button to engage protruding teeth (i.e., the first tooth and the second tooth 141) respectively with gears (i.e., the first gear 10 and the second gear 15), thereby fixing the mount in the desired location. Therefore, this mount offers a technical effect of allowing single-handed control of the rotatable joints to rotate to the desired location.

Furthermore, in one embodiment of the mount, as shown in FIGS. 1-5, the first tooth 91 and the second tooth 141 are pawls, and the first gear 10 and the second gear 15 are ratchets. The ratchets and pawls allow the rotatable joints to rotate against gravity in any situation, while under gravity, the ratchets and pawls must be separated to allow rotations of the rotatable joints.

Furthermore, in one embodiment of the mount, as shown in FIGS. 1-5, the at least one connecting line 11 comprises a steel cable disposed therein and a protective sleeve sleeved on the steel cable. The at least one connecting line 11 has a structure similar to a bicycle brake cable, so that the at least one connecting line 11 is able to go around the rotatable joint where the first support rod 2 and the second support rod 12 are connected without affecting a transmission of a tension.

Furthermore, in one embodiment of the mount, as shown in FIGS. 1, 2, and 4, the main slider comprises a button slider 6 and a first limiting slider 9. The button slider 6 and the first limiting slider 9 are slidably disposed in the first support rod 2. The button slider 6 and the first limiting slider 9 are connected and linked by a joint rod 7. The first tooth 91 is disposed on a front end of the first limiting slider 9.

Furthermore, in one embodiment of the mount, as shown in FIGS. 1, 2, and 4, a second elastic device is sleeved on the joint rod 7, and the second elastic device is a compression spring. The compression spring is disposed between the first limiting slider 9 and an inner wall of the first support rod 2.

Furthermore, in one embodiment of the mount, as shown in FIGS. 1, 3, and 5, a clamping slot 92 is defined on the first limiting slider 9. The first end of the at least one connecting line 11 is clamped in the clamping slot 92 of the first limiting slider 9. The second end of the at least one connecting line 11 is fixed to a second limiting slider 14. The second tooth 141 is disposed on a front end of the second limiting slider 14. The first elastic device 13 is disposed between the second limiting slider 14 and the second support rod 12.

Furthermore, in one embodiment of the mount, as shown in FIGS. 1-3, the button comprises a button shell 3. A pressing block 4 is fixed on the button shell 3. A first end of a connecting rod 5 is rotatably connected to the pressing block 4. A second end of the connecting rod 5 is rotatably connected in the button slider 6. When the button shell 3 is pressed, the pressing block 4 moves inward along a radial direction of the first support rod 2, so that the connecting rod 5 swings and drives the button slider 6 to slide forward, thereby causing the first limiting slider to slide forward.

Furthermore, in one embodiment of the mount, as shown in FIGS. 1-3, a front end of the first support rod 2 is connected to a ball head assembly 1.

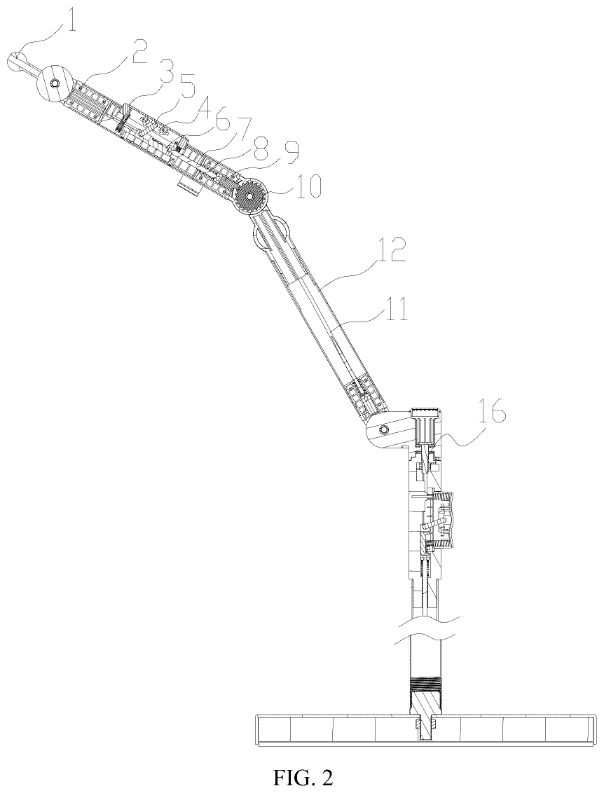

Furthermore, in one embodiment of the mount, as shown in FIGS. 1-2, the first limiting slider 9 is slidably disposed on the rear end of the first support rod 2, and the first gear 10 is fixed to an end of the second support rod 12 close to the first support rod 2.

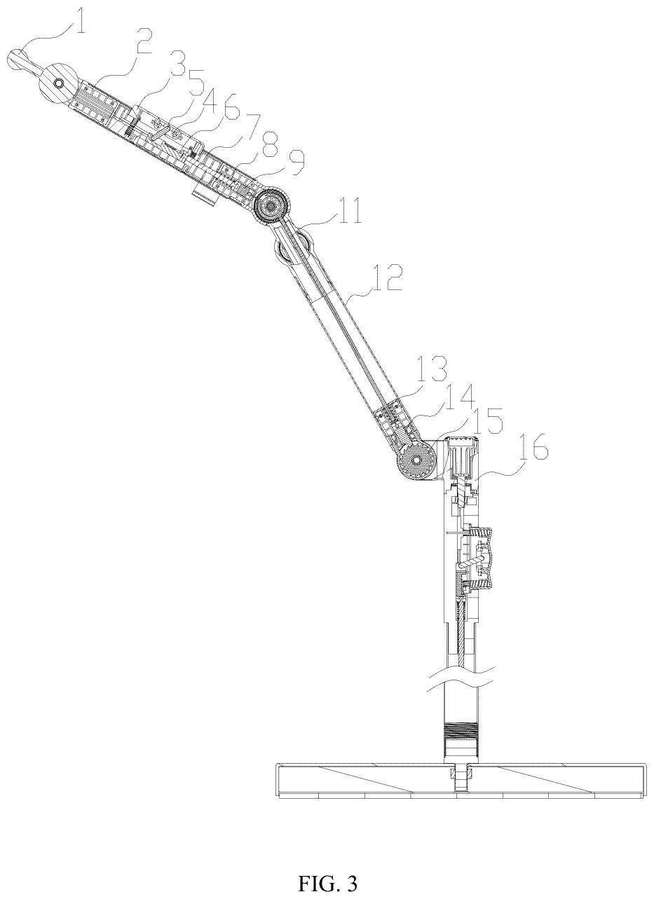

Furthermore, in one embodiment of the mount, as shown in FIGS. 1 and 3, the second limiting slider 14 is slidably disposed on a rear end of the second support rod 12, and the second gear 15 is fixed to one end of the third support rod 16 close to the second support rod 12.

The above describes the mount of the present disclosure to help understand the present disclosure. However, the implementation of the present disclosure is not limited to the above embodiments. Any changes, modifications, substitutions, combinations, or simplifications made without departing from the principle of the present disclosure should be considered equivalent substitutions and are comprised within the protection scope of the present disclosure.

What is claimed is:

1. A mount for single-handed control of rotatable joints, comprising:
a first support rod;
wherein a rear end of the first support rod is rotatably connected to a second support rod and a third support rod, and the second support rod and the third support rod are connected in sequence;
wherein a button is disposed on the first support rod, a main slider is disposed in the first support rod, a first tooth is disposed at a rear end of the main slider, a first gear is fixed at a rotatable joint of the first support rod and the second support rod, and the first tooth is configured to limit a rotation of the first support rod relative to the second support rod when the first tooth is engaged with the first gear;
wherein the main slider is connected with a first end of at least one connecting line, a second tooth is disposed on a second end of the at least one connecting line, a second gear is fixed at a rotatable joint of the second support rod and the third support rod, and the second tooth is configured to limit a rotation of the second support rod relative to the third support rod when the second tooth is engaged with the second gear;
wherein a first elastic device is disposed on the second tooth, when the button is pressed, the main slider slides forward to deform the first elastic device, so that the first tooth disengages from the first gear and the second tooth disengages from the second gear, and the first support rod and the second support rod are rotatable relative to each other;
wherein when the button resets, the first elastic device resets to slide the main slider backward, so that the first tooth is engaged with the first gear to limit the rotation of the first support rod relative to the second support rod, and the second tooth is engaged with the second gear to limit the rotation of the second support rod relative to the third support rod.

2. The mount according to claim 1, wherein the first tooth and the second tooth are pawls, and the first gear and the second gear are ratchets.

3. The mount according to claim 1, wherein the at least one connecting line comprises a steel cable disposed therein and a protective sleeve sleeved on the steel cable.

4. The mount according to claim 1, wherein the main slider comprises a button slider and a first limiting slider;
wherein the button slider and the first limiting slider are slidably disposed in the first support rod, the button slider and the first limiting slider are connected and linked by a joint rod, and the first tooth is disposed on a front end of the first limiting slider.

5. The mount according to claim 4, wherein a second elastic device is disposed between the first limiting slider and the first support rod.

6. The mount according to claim 4, wherein the first end of the at least one connecting line is fixed on the first limiting slider, the second end of the at least one connecting line is fixed to a second limiting slider, the second tooth is disposed on a front end of the second limiting slider, and the first elastic device is disposed between the second limiting slider and the second support rod.

7. The mount according to claim 1, wherein the button comprises a button shell, a pressing block is fixed on the button shell, a first end of a connecting rod is rotatably connected to the pressing block, and a second end of the connecting rod is rotatably connected to the main slider;
wherein when the button shell is pressed, the pressing block moves inward along a radial direction of the first support rod, so that the connecting rod swings and drives the main slider to slide forward.

8. The mount according to claim 1, wherein a front end of the first support rod is connected to a ball head assembly.

9. The mount according to claim 4, wherein the first limiting slider is slidably disposed on the rear end of the first support rod, and the first gear is fixed to an end of the second support rod close to the first support rod.

10. The mount according to claim 6, wherein the second limiting slider is slidably disposed on a rear end of the second support rod, and the second gear is fixed to one end of the third support rod close to the second support rod.
